(19) United States
(12) Patent Application Publication
(10) Pub. No.: US 2009/0145463 A1
(43) Pub. Date: Jun. 11, 2009

(54) Ozonated water mixture supply apparatus and method, and substrate treating facility with the apparatus

(75) Inventors: Rae-Taek Oh, Cheonan-si (KR); Choon-Sik Kim, Cheonan-si (KR); Jeong-Yong Bae, Cheonan-si (KR)

Correspondence Address: HARNESS, DICKEY & PIERCE, P.L.C., P.O. BOX 8910, RESTON, VA, 20195, US

(73) Assignee: SEMES CO., LTD.

(21) Appl. No.: 12/289,751

(22) Filed: Nov. 3, 2008

(30) Foreign Application Priority Data
Dec. 6, 2007 (KR) 2007-126055

(51) Int. Cl. B08B 7/04; B08B 13/00; B01F 15/02

(52) U.S. Cl. 134/18; 134/201; 134/153; 366/154.1

(57) ABSTRACT

Provided are an ozonated water mixture supply apparatus and method, and a substrate treating facility that receives an ozonated water mixture from the apparatus to treat a substrate. The ozonated water mixture supply apparatus includes a mixing line and distribution lines. The mixing line respectively receives a treating liquid and an ozonated water from a treating liquid supply line and an ozonated water supply line and mixes the treating liquid and the ozonated water to generate the ozonated water mixture satisfying a previously set concentration. Each of the distribution lines distributes the ozonated water mixture generated from the mixing line into a process unit. The mixing line includes a mixing valve and a static mixer. Therefore, the ozonated water mixture having the previously set concentration is generated and supplied using an in-line mixing method without requiring a mixing vessel such as a mixing tank.

### CROSS-REFERENCE TO RELATED APPLICATIONS

This U.S. non-provisional patent application claims priority under 35 U.S.C. §119 of Korean Patent Application No. 10-2007-0126055, filed on Dec. 6, 2007, the entire contents of which are hereby incorporated by reference.

### BACKGROUND OF THE INVENTION

The present invention disclosed herein relates to an ozonated water mixture supply apparatus and method, and a substrate treating facility that receives an ozonated water mixture from the apparatus to treat a substrate.

A cleaning process of a semiconductor manufacturing process is a process for removing a foreign substance remaining on a wafer. A wet cleaning process of the cleaning process cleans the foreign substance remaining on the wafer using various treating liquids. For example, an ozone cleaning process of the wet cleaning process removes a photoresist liquid and an organic pollutant remaining on the wafer using a solution mixing ozone with ultrapure water or treating liquid (hereinafter, referred to as an “ozonated water mixture”).

An apparatus for performing the ozone cleaning process includes a mixing vessel, a buffer vessel, and a circulation line. The mixing vessel provides a space that receives the treating liquid and the ozone and mixes them to generate the ozonated water mixture. The ultrapure water or various acid-alkaline chemical liquids may be used for the treating liquid. A mixing tank is used as the mixing vessel. The buffer vessel receives the ozonated water mixture from the mixing vessel to supply the ozonated water mixture to a process unit that sprays the ozonated water mixture onto a wafer to clean the wafer. The circulation line circulates the ozone and the treating liquid within the mixing vessel to generate the ozonated water mixture that satisfies a previously set process concentration. A concentration meter is disposed in the circulation line.

However, it is difficult to control a concentration in the above-described ozone cleaning apparatus. That is, the ozone (O₃) is easily decomposed into oxygen gases (an oxygen molecule (O₂) and an oxygen atom (O)). Thus, since a concentration of the ozonated water mixture that is generated and stored in the mixing vessel becomes more and more dilute, it is difficult to control the concentration of the ozonated water mixture. Also, when a period of time in which the ozonated water mixture is supplied to an ongoing unit increases, the concentration of the ozonated water mixture that is in a supply standby state in the apparatus is changed. Thus, it is difficult to maintain the concentration of the ozonated water mixture. When the ozonated water mixture that does not satisfies an optimum concentration is used, cleaning efficiency is reduced.

### SUMMARY OF THE INVENTION

The present invention provides an ozonated water mixture supply apparatus and method, and a substrate treating facility with the apparatus.

The present invention also provides an ozonated water mixture supply apparatus and method that can effectively control a concentration of an ozonated water mixture, and a substrate treating facility with the apparatus.

The present invention further provides an ozonated water mixture supply apparatus and method that can precisely and easily control a concentration of an ozonated water mixture, and a substrate treating facility with the apparatus.

Embodiments of the present invention provide ozonated water mixture supply apparatuses including: a treating liquid supply line supplying a treating liquid; an ozonated water supply line supplying an ozonated water; and a mixing line respectively receiving the treating liquid and the ozonated water from the treating liquid supply line and the ozonated water supply line and mixing the treating liquid and the ozonated water using an in-line mixing method to generate an ozonated water mixture.

In some embodiments, the ozonated water mixture supply apparatuses may further include a manifold receiving the ozonated water mixture generated by the mixing line; and a distribution line distributing the ozonated water mixture from the manifold to a process unit in which a substrate treating process is performed.

In other embodiments, the ozonated water mixture supply apparatuses may further include a mixing valve disposed in the mixing line so as to supply and block the treating liquid and the ozonated water from the treating liquid supply line and the ozonated water supply line to the mixing line; and a static mixer disposed in the mixing line so as to mix the treating liquid and the ozonated water flowing along the mixing line.

In other embodiments of the present invention, substrate treating facilities include: a plurality of process units performing a substrate treating process; a treating liquid storage unit storing a treating liquid; an ozonated water mixture generating unit receiving the treating liquid from the treating liquid storage unit to generate an ozonated water mixture; and an ozonated water mixture distribution unit distributing the ozonated water mixture generated in the ozonated water mixture generation unit into each of the process units, wherein the ozonated water mixture generating unit includes: a treating liquid supply line supplying a treating liquid; an ozonated water supply line supplying an ozonated water; and a mixing line respectively receiving the treating liquid and the ozonated water from the treating liquid supply line and the ozonated water supply line and mixing the treating liquid and the ozonated water using an in-line mixing method to generate an ozonated water mixture.

In some embodiments, the ozonated water mixture distribution unit may include: a manifold receiving the ozonated water mixture generated by the mixing line; and a distribution line distributing the ozonated water mixture from the manifold to a process unit in which a substrate treating process is performed.

In other embodiments, the ozonated water mixture generation unit may further include: a mixing valve disposed in the mixing line so as to supply and block the treating liquid and the ozonated water from the treating liquid supply line and the ozonated water supply line to the mixing line; and a static mixer disposed in the mixing line so as to mix the treating liquid and the ozonated water flowing along the mixing line.

In still other embodiments, the process unit may include: a spin chuck horizontally supporting a substrate; and a nozzle supplying the ozonated water mixture onto the substrate disposed on the spin chuck.

In still other embodiments of the present invention, ozonated water mixture supply methods include: mixing a treating liquid and an ozonated water to generate an ozonated water mixture and measure a concentration of the generated ozonated water mixture, whereby supplying the ozonated water mixture into a process unit in which a substrate treating process is performed when the measured concentration of the ozonated water mixture satisfies a previously set concentration range, wherein the mixing of the treating liquid and the ozonated water is performed using an in-line mixing method.

In some embodiments, the mixing of the treating liquid and the ozonated water may be performed by disposing a mixing valve and a static mixer in a line in which the treating liquid and the ozonated water flow.

In other embodiments, the process unit may include a unit cleaning a substrate in a single wafer process.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a view of a substrate treating facility according to the present invention;

FIG. 2 is a view of a process chamber of FIG. 1;

FIG. 3 is a flowchart illustrating an ozonated water mixture supply method according to the present invention; and

FIGS. 4A through 4E are views illustrating an ozonated water mixture supply process according to the present invention.

### DETAILED DESCRIPTION OF PREFERRED EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Embodiments of the present invention explain a single wafer process (SWP) cleaning facility for removing a foreign substance remaining on a surface of a semiconductor substrate as an example. However, the present invention may apply all apparatuses using an ozonated water mixture.

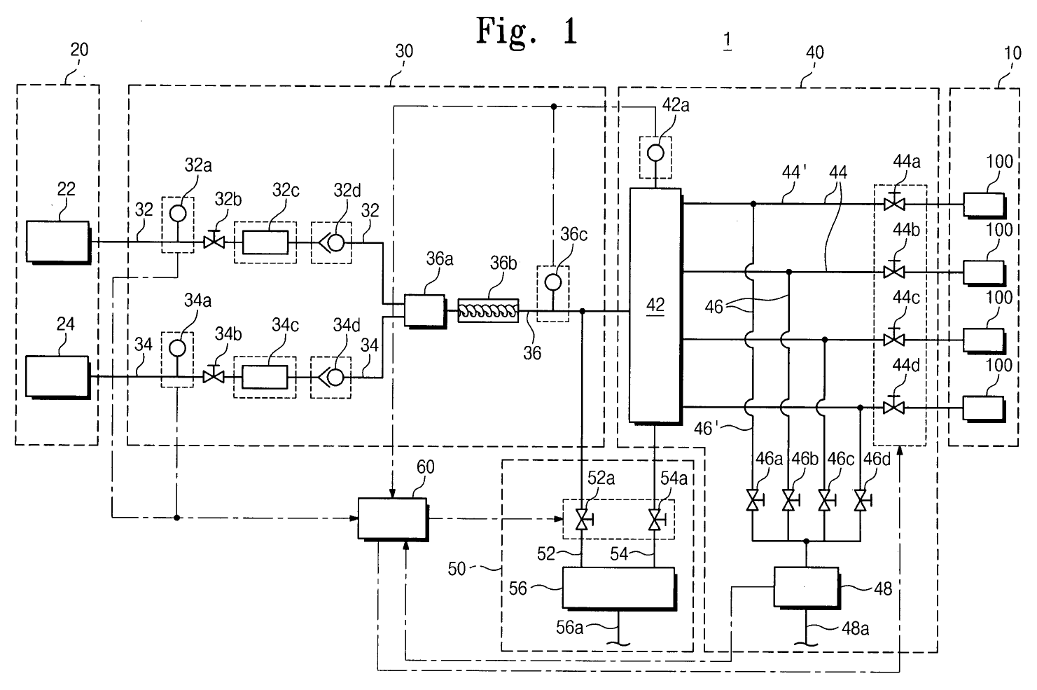

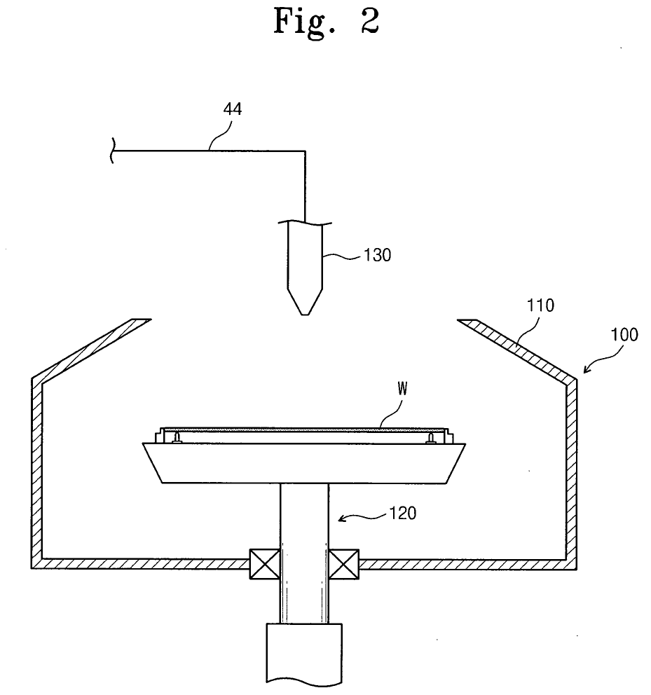

FIG. 1 is a view of a substrate treating facility according to the present invention, and FIG. 2 is a view of a process chamber of FIG. 1.

Referring to FIGS. 1 and 2, a substrate treating facility according to the present invention 1 performs processes for treating a semiconductor substrate (hereinafter, referred to as a “wafer W”). The substrate treating facility 1 includes a process unit 10, an ozonated water mixture supply units 20, 30, and 40, a drain unit 50, and a control unit 60.

The process unit 10 performs a cleaning process for removing a foreign substance remaining on the wafer W. The ozonated water mixture supply units 20, 30, and 40 generate an ozonated water mixture to supply the produced ozonated water mixture to the process unit 10. The ozonated water mixture is a mixture of ozonated water and treating liquid. Various acid-alkaline chemical liquids may be used as the treating liquid. The ozonated water mixture units 20, 30, and 40 include a treating-fluid storage unit 20, an ozonated water mixture generating unit 30, and an ozonated water mixture distribution unit 40. The drain unit 50 drains the ozonated water mixture within the ozonated water mixture generating unit 30 and the ozonated water mixture distribution unit 40. The control unit 60 controls the process unit 10, the ozonated water mixture supply units 20, 30, and 40, and the drain unit 50.

The ozonated water mixture supply units 20, 30, and 40 generate and supply the ozonated water mixture using an in-line mixing method. In the in-line mixing method, the mixture of the ozonated water and the treating liquid is not stored in a storage vessel such as a tank, but are mixed while the ozonated water and treating liquid are supplied to the process unit 10. Thus, a unit in which a supply of the ozonated water and the treating liquid are stagnated (e.g., a mixing tank that receives the ozonated water and the treating liquid to mix and store them) is not provided in the ozonated water mixture supply units 20, 30, and 40.

The process unit 10 includes a plurality of process chambers 100. Referring to FIG. 2, each of process chambers 100 receives the ozonated water mixture from the ozonated water mixture supply units 20, 30, and 40 to clean the wafer W in a single wafer process during processing. The process chamber 100 includes a housing 110, a spin chuck 120, and a nozzle 130. The housing 110 provides a space for performing the cleaning process therein. The housing 110 has a cup shape having an opened upper portion. The opened upper portion is used as a passage for loading/unloading the wafer W. The spin chuck supports and rotates the wafer W inside the housing 110 during processing. The nozzle 130 receives the ozonated water mixture from the ozonated water mixture supply units 20, 30, and 40 to spray the ozonated water mixture onto a treatment surface of the wafer W disposed on the spin chuck 120 during processing.

The treating-fluid storage unit 20 stores the treating liquid for generating the ozonated water mixture. The treating-fluid storage unit 20 includes a treating liquid supply source 22 and an ozone supply source 24. the treating liquid supply source 22 stores the treating liquid, and the ozone supply source 24 stores the ozonated water. A hydro fluoric acid (HF) may be used as the treating liquid. Although the ozonated water mixture having a predetermined concentration is generated by mixing the HF with the ozonated water in this embodiment, the present invention is not limited thereto. For example, various treating liquids may be used.

The ozonated water mixture generating unit 30 receives a treating fluid from the treating-fluid storage unit 20 to generate the ozonated water mixture. The ozonated water mixture generating unit 30 includes a treating liquid supply line 32, an ozonated water supply line 34, and a mixing line 36.

The treating liquid supply line 32 supplies the treating liquid from the treating liquid supply source 22 to the mixing line 36. The ozonated water supply line 34 supplies ozone from the ozone supply source 24 to the mixing line 36. A first pressure gauge 32a, a first pressure control valve 32b, a first flow meter 32c, and a first back pressure valve 32d are disposed in the treating liquid supply line 32. The first pressure gauge 32a measures a treating liquid supply pressure of the treating liquid supply line 32. The first pressure control valve 32b may control a supply pressure of the treating liquid supply line 32 so that a flow amount of the treating liquid supplied from the treating liquid supply line 32 satisfies a previously set flow amount. The first flow meter 32c measures the flow amount of the treating liquid supplied from the treating liquid supply line 32. The first back pressure valve 32d prevents the treating liquid from back flowing from the mixing line 36 to the treating liquid supply line 32 in case where a supply pressure of the mixing line 36 is greater than that of the treating liquid supply line 32.

The ozonated water supply line 34 has the same constitution as that of the treating liquid supply line 32. That is, a second pressure gauge 34a, a second pressure control valve 34b, a second flow meter 34c, and a second back pressure valve 34d are disposed in the ozonated water supply line 34. The second pressure gauge 34a measures an ozonated water supply pressure of the ozonated water supply line 34. The second pressure control valve 34b may control a supply pressure of the ozonated water supply line 34 so that a flow amount of the ozonated water supplied from the ozonated water supply line 34 satisfies a previously set flow amount. The second flow meter 34c measures the flow amount of the ozonated water supplied from the ozonated water supply line 34. The second back pressure valve 34d prevents the ozonated water from back flowing from the mixing line 36 to the ozonated water supply line 34.

The mixing line 36 receives the treating liquid and the ozonated water from the treating liquid supply line 32 and the ozonated water supply line 34 to mix them. A mixing valve 36a, a static mixer 36b, and a third pressure gauge 36c are disposed in the mixing line 36. The mixing valve 36a may efficiently open and close the treating liquid supply line 32 and the ozonated water supply line 34 to precisely control supply amount of the treating liquid and the ozonated water when the treating liquid supply line 32 and the ozonated water supply line 34 are opened. The static mixer 36b efficiently mixes the treating liquid and the ozone flowing into the mixing line 36. The third pressure gauge 36c measures an ozonated water supply pressure of the mixing line 36 to transmit the measured pressure date to the control unit 60.

The ozonated water mixture distribution unit 40 distributes the ozonated water mixture generated by the ozonated water mixture generating unit 30 to the process chambers 100 of the process unit 10. The ozonated water mixture distribution unit 40 includes a manifold 42, a distribution line 44, and a concentration detecting member. The concentration detecting member includes a concentration check line 46 and a concentration meter 48. The manifold 42 receives the ozonated water mixture generated by the mixing line 36. A fourth pressure gauge 42a is disposed in the manifold 42. The fourth pressure gauge 42a measures a pressure within the manifold 42 to transmit the measured pressure data to the control unit 60. The distribution line 44 supplies the ozonated water mixture from the manifold 42 to the process unit 10. The distribution line 44 is provided in plurality. Each of distribution lines 44 supplies the ozonated water mixture from the manifold 42 to the process unit 10. The concentration check line 46 checks a concentration of the ozonated water within the distribution line 44. The concentration check line 46 has one ends respectively connected to the distribution lines 44 different from each other. The concentration meter 48 is disposed in the concentration check line 46 to measure a concentration of the ozonated water mixture flowing along the concentration check line 46. The concentration data measured by the concentration meter 48 is transmitted to the control unit 60.

The drain unit 50 drains the ozonated water mixture within the ozonated water mixture generating unit 30 and the ozonated water mixture distribution unit 40. The drain unit 50 includes a first drain line 52, a second drain line 54, and a drain vessel 56. The first drain line 52 has one end connected to the mixing line 36 and the other end connected to the drain vessel 56. Thus, when a pressure within the mixing line 36 is beyond a previously set pressure range, the first drain line 52 drains the ozonated water mixture within the mixing line 36. In order to speedily drain the ozonated water, a relief valve may be used as a valve 52a disposed in the first drain line 52. Thus, when the pressure within the mixing line 52 is beyond the previously set pressure range, the valve 52a is automatically opened to allow the first drain line 52 to drain the ozonated water mixture within the mixing line 52.

The second drain line 54 has one end connected to the manifold 42 and the other end connected to the drain vessel 56. Thus, the second drain line 54 drains the ozonated water mixture within the manifold 42 into the drain vessel 56. A flow control valve may be used as a valve 54a disposed in the second drain line 54. That is, the valve 54a may control a drain amount of the ozonated water mixture within the manifold 42 to control a drain amount of the ozonated water mixture within the second drain line 54. Also, a relief valve having the same function as that of the valve 52a disposed in the first drain line 52 may be used as the valve 54a. The drain vessel 56 stores the ozonated water mixture flowing through the first and second drain lines 52 and 54. The ozonated water mixture stored in the drain vessel 56 is discharged outside the facility 1 through a discharging line 56a.

The control unit 60 controls the above-described units 10, 20, 30, 40, and 50. Detailed processes of controlling the above-described units 10, 20, 30, 40, and 50 under the control unit 60 will be described later.

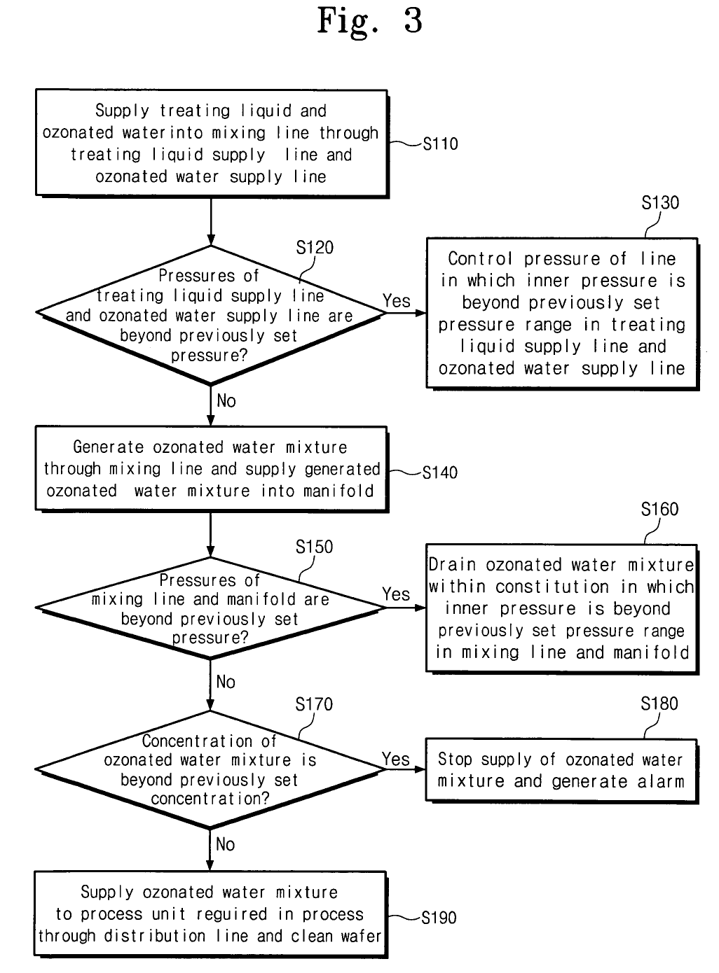

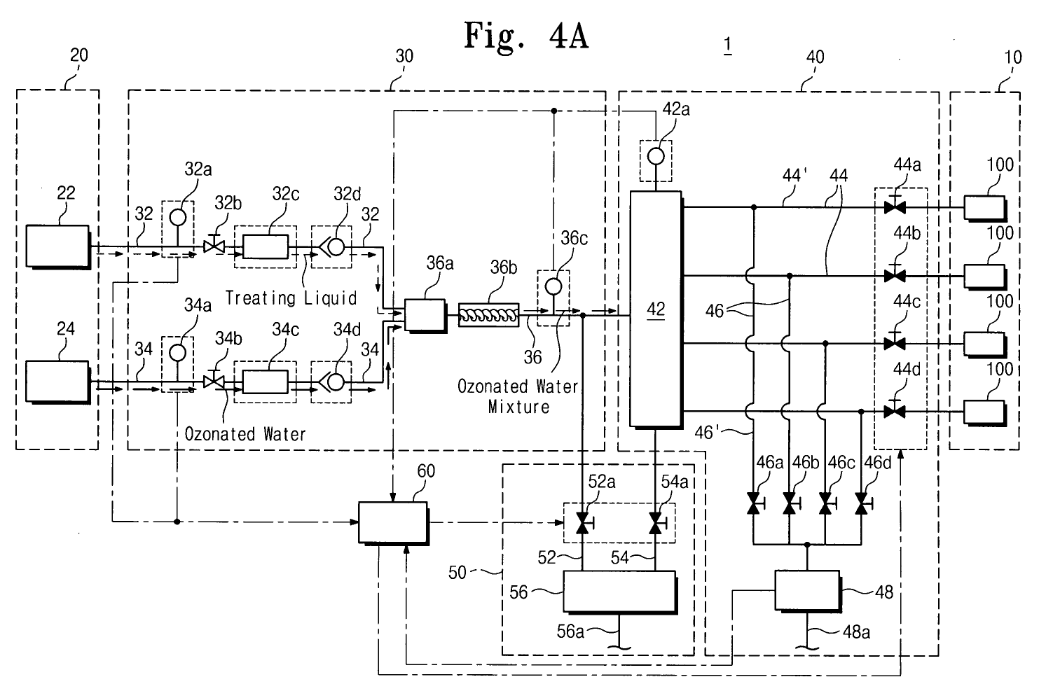

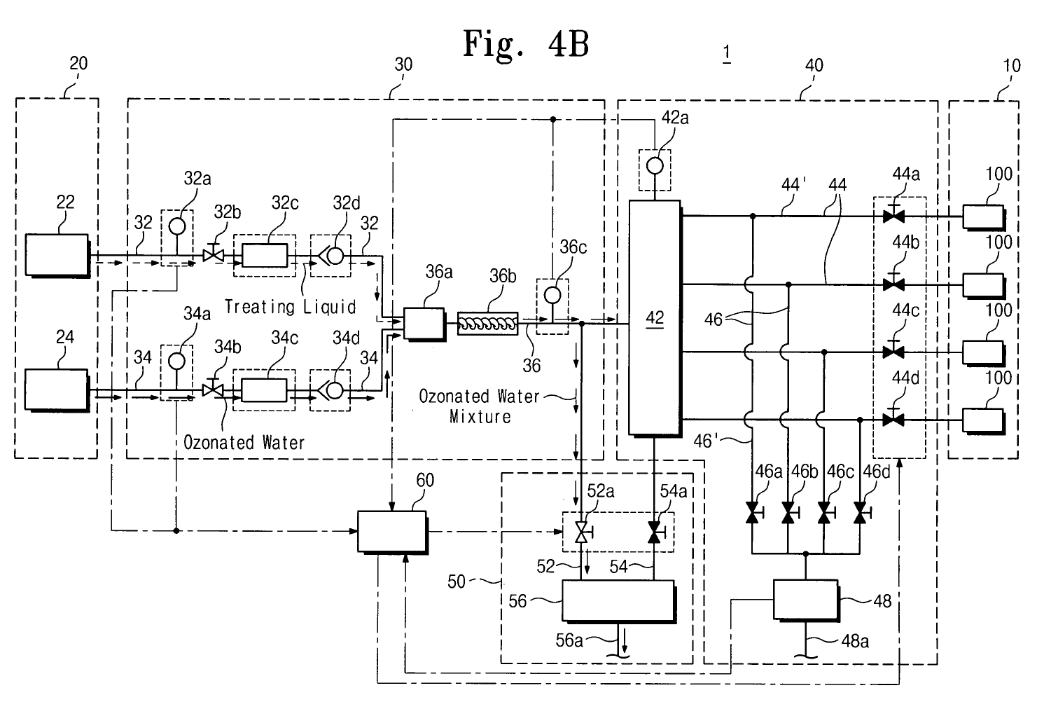

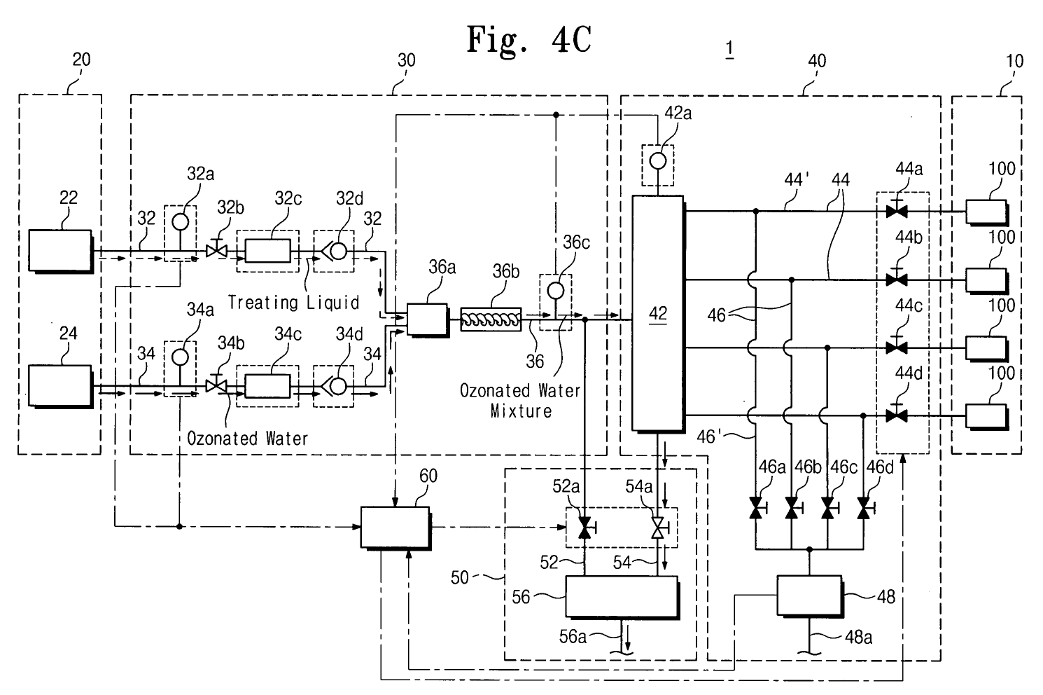

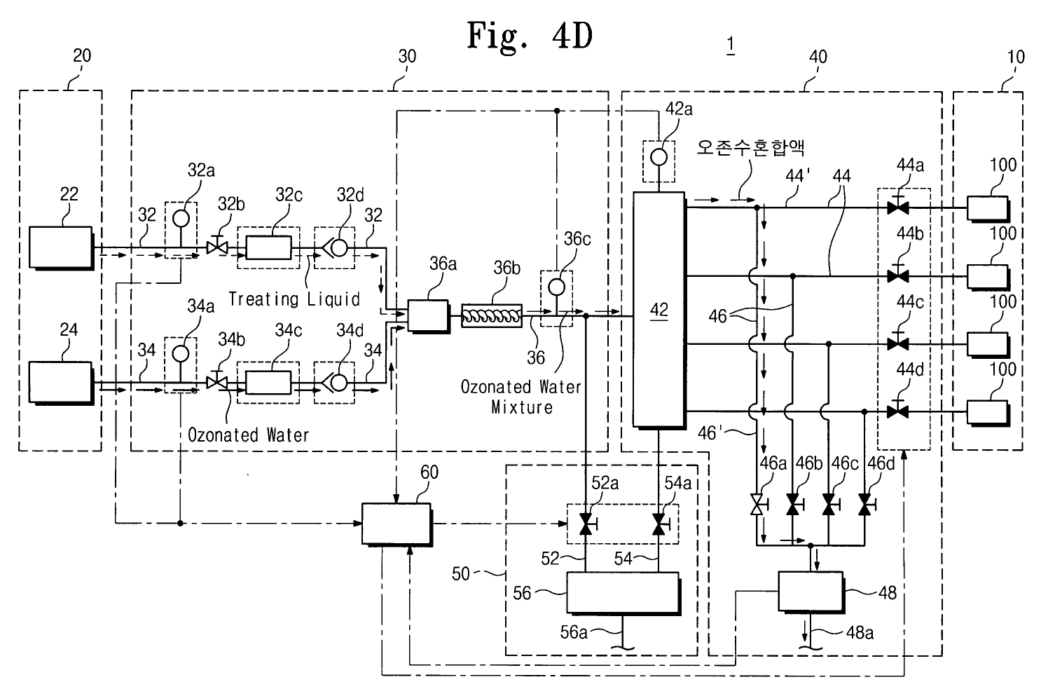

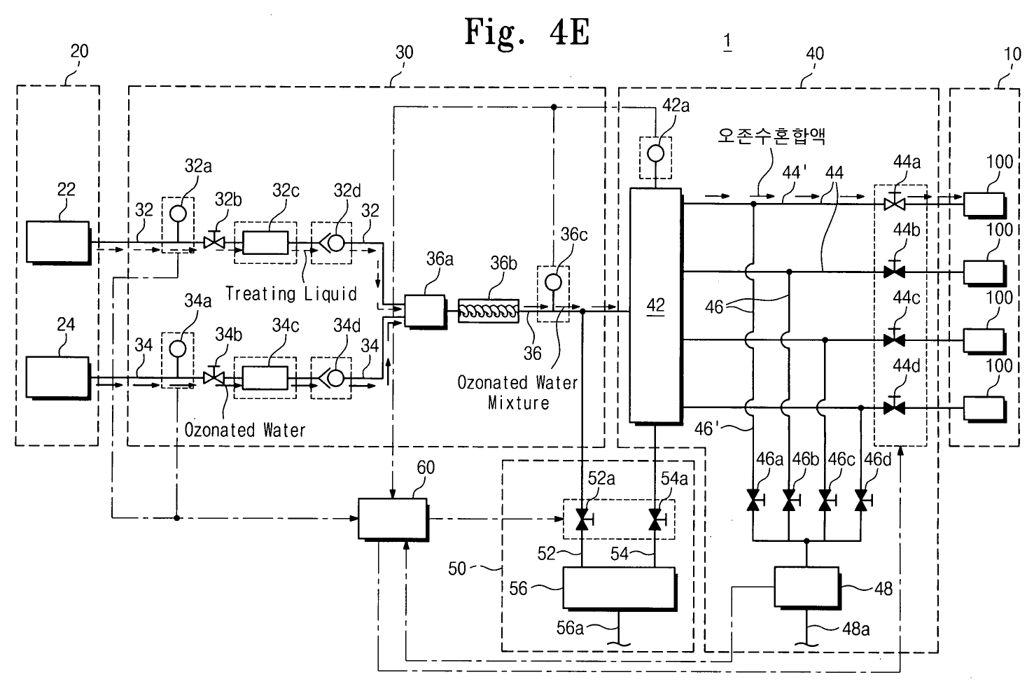

A treating process of the substrate treating facility 1 according to the present invention will now be described in detail with reference to FIG. 3. FIG. 3 is a flowchart illustrating an ozonated water mixture supply method according to the present invention, and FIGS. 4A through 4E are views illustrating an ozonated water mixture supply process according to the present invention.

In operation S110, a treating liquid supply line 32 and an ozonated water supply line 34 supply a treating liquid and an ozonated water to a mixing line 36, respectively. Referring to FIG. 4A, a control unit 60 opens a mixing line 36. The treating liquid supply line 32 supplies the treating liquid from a treating liquid supply source 22 to the mixing line 36. The ozonated water supply line 34 supplies the ozonated water from an ozone supply source 24 to the mixing line 36. In operation S120, the control unit 60 determines whether pressures measured by first and second pressure gauges 32a and 34a are beyond a previously set pressure range. In operation S130, when the pressures measured by first and second pressure gauges 32a and 34a are beyond the previously set pressure range, the measured pressures are displayed on an external display of a facility 1 so that an operator recognizes it. That is, the control unit 60 determines whether supply pressures of the ozonated water supply line 34 and the treating liquid supply line 32 are beyond the previously set pressure range. This is done because flow amount measurement efficiency of first and second flow meters 32c and 34c is reduced to change a concentration of the ozonated water mixture generated by the mixing line 36 when the supply pressures of the ozonated water supply line 34 and the treating liquid supply line 32 are changed. Also, the control unit 60 determines whether a treating liquid supply flow amount of the treating liquid supply line 32 and an ozonated water supply flow amount of the ozonated water supply line 34 measured by the first and second flow meters 32c and 34c are beyond a previously set supply flow amount range. When the supply flow amounts of the treating liquid and the ozonated water measured by the first and second flow meters 32c and 34c are beyond the previously set supply flow amount range, the measured supply flow amounts are displayed on the external display of the facility 1 so that the operator recognizes it. The operator controls first and second pressure control valves 32b and 34b to control the supply flow amount of the treating liquid and the ozonated water.

In operation S140, the treating liquid and the ozonated water flowing into the mixing line 36 are mixed while the treating liquid and the ozonated water flow along the mixing line 36, and then supplied to a manifold 42. That is, the treating liquid and the ozonated water flowing along the mixing line 36 are mixed by a static mixer 36b to generate the ozonated water mixture satisfying a previously set concentration. Thereafter, the ozonated water mixture is supplied to the manifold 42.

In operation S150, during generation of the ozonated water mixture by the mixing line 36, the control unit 60 determines whether pressures within the mixing line 36 and the manifold 42 are beyond a previously set pressure range. That is, when the pressures within the mixing line 36 and the manifold 42 are beyond the previously set pressure range (e.g., the pressures exceed the previously set pressure range), it is difficult to generate the ozonated water mixture satisfying a previously set concentration because mixing efficiency of the treating liquid and the ozonated water is reduced. Thus, when the pressures within the mixing line 36 and the manifold 42 are beyond the previously set pressure range, the control unit 60 controls the pressures within the mixing line 36 and the manifold 42 to the previously set pressure.

Referring to FIG. 4B, when an ozonated water mixture supply pressure of the mixing line 36 measured by a third pressure gauge 36c exceeds a previously set pressure range, the valve 52a is automatically opened to drain the ozonated water mixture within the mixing line 36 into a drain vessel 56 through a first drain line 52 in operation S160. When the ozonated water mixture within the mixing line 36 is drained from the mixing line 36, the supply pressure of the mixing line 36 is reduced. When the pressure of the mixing line 36 satisfies the previously set pressure, the control unit 60 closes the valve 52a to stop the drain of the ozonated water mixture of the first drain line 52.

Referring to FIG. 4C, a pressure within the manifold 42 measured by a fourth pressure gauge 42a exceeds a previously set pressure range, the control unit 60 opens a valve 54a to drain the ozonated water mixture within the manifold 42 into the drain vessel 56 through the second drain line 54 in operation S160. When the ozonated water mixture within the manifold 42 is drained from the manifold 42, the pressure within the manifold 42 is reduced. When the pressure of the manifold 42 satisfies the previously set pressure, the control unit 60 closes the valve 54a to stop the drain of the ozonated water mixture within the manifold 42 of the second drain line 54.

When the generated ozonated water mixture is received into the manifold 42, an ozonated water mixture distribution unit 40 supplies the ozonated water mixture to a process chamber required for a process among process chambers 100. In operation S170, the control unit 60 determines whether a concentration of the ozonated water mixture within a distribution line through which the ozonated water mixture is supplied into the process chamber 100 among distribution lines 44 is beyond a previously set concentration range. Referring to FIG. 4D, the control unit 60 opens a valve 46a disposed in a concentration check line 46′ connected to any one distribution line 44′ required for the presses among the distribution lines 44. A concentration meter 48 determines whether a concentration of the ozonated water mixture flowing along the concentration check line 46′ is beyond a previously set concentration range. In operation S180, when the concentration of the ozonated water mixture measured by the concentration meter 48 is beyond the previously set concentration range, the control unit 60 stops the supply of the ozonated water mixture of the distribution line 44′ in which the concentration check is performed and allows the external display of the facility 1 to display it so that the operator recognizes it.

In operation S190, when the concentration of the ozonated water mixture measured by the concentration meter 48 satisfies the previously set concentration, the distribution line 44 supplies the ozonated water mixture to the process unit 10, and the process unit 10 receives the ozonated water mixture to perform a cleaning process. Referring to FIG. 4E, the control unit 60 opens the valve 44a, and the distribution line 44′ supplies the ozonated water mixture satisfying the previously set concentration to the process unit 10. The process unit 10 sprays the supplied ozonated water mixture onto a wafer W. The sprayed ozonated water mixture removes a foreign substance remaining on a surface of the wafer W and is discharged outside the process unit 10.

As described above, the present invention generates the ozonated water mixture using the in-line mixing method and supplies the generated ozonated water mixture to the process unit to increase the efficiency of the substrate treating process. Furthermore, the present invention can generate and supply the ozonated water mixture satisfying the previously set concentration and control the concentration without requiring the mixing vessel such as the conventional mixing tank. Thus, the present invention can minimize a stagnation section of the ozonated water mixture within the ozonated water mixture supply unit and decompose the ozone within the ozonated water mixture of the mixing vessel to prevent the concentration of the ozonated water mixture from being diluted.

In addition, the present invention can measure the concentration of the ozonated water mixture within each of the distribution lines for distributing the ozonated water mixture into the process units to selectively drain the ozonated water mixture within the distribution line in which the ozonated water mixture beyond the previously set concentration remains, whereby minimizing the drain amount of the ozonated water mixture.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An ozonated water mixture supply apparatus comprising:
a treating liquid supply line supplying a treating liquid;
an ozonated water supply line supplying an ozonated water; and
a mixing line respectively receiving the treating liquid and the ozonated water from the treating liquid supply line and the ozonated water supply line and mixing the treating liquid and the ozonated water using an in-line mixing method to generate an ozonated water mixture.

2. The ozonated water mixture supply apparatus of claim 1, further comprising:
a manifold receiving the ozonated water mixture generated by the mixing line; and
a distribution line distributing the ozonated water mixture from the manifold to a process unit in which a substrate treating process is performed.

3. The ozonated water mixture supply apparatus of claim 1, further comprising:
a mixing valve disposed in the mixing line so as to supply and block the treating liquid and the ozonated water from the treating liquid supply line and the ozonated water supply line to the mixing line; and
a static mixer disposed in the mixing line so as to mix the treating liquid and the ozonated water flowing along the mixing line.

4. A substrate treating facility comprising:
a plurality of process units performing a substrate treating process;
a treating liquid storage unit storing a treating liquid;
an ozonated water mixture generating unit receiving the treating liquid from the treating liquid storage unit to generate an ozonated water mixture; and
an ozonated water mixture distribution unit distributing the ozonated water mixture generated in the ozonated water mixture generation unit into each of the process units,
wherein the ozonated water mixture generating unit comprises:
a treating liquid supply line supplying a treating liquid;
an ozonated water supply line supplying an ozonated water; and
a mixing line respectively receiving the treating liquid and the ozonated water from the treating liquid supply line and the ozonated water supply line and mixing the treating liquid and the ozonated water using an in-line mixing method to generate an ozonated water mixture.

5. The substrate treating facility of claim 4, wherein the ozonated water mixture distribution unit comprises:
a manifold receiving the ozonated water mixture generated by the mixing line; and
a distribution line distributing the ozonated water mixture from the manifold to a process unit in which a substrate treating process is performed.

6. The substrate treating facility of claim 4, wherein the ozonated water mixture generation unit further comprises:
a mixing valve disposed in the mixing line so as to supply and block the treating liquid and the ozonated water from the treating liquid supply line and the ozonated water supply line to the mixing line; and
a static mixer disposed in the mixing line so as to mix the treating liquid and the ozonated water flowing along the mixing line.

7. The substrate treating facility of claim 6, wherein the process unit comprises:
a spin chuck horizontally supporting a substrate; and
a nozzle supplying the ozonated water mixture onto the substrate disposed on the spin chuck.

8. An ozonated water mixture supply method comprising:
mixing a treating liquid and an ozonated water to generate an ozonated water mixture and measure a concentration of the generated ozonated water mixture, whereby supplying the ozonated water mixture into a process unit in which a substrate treating process is performed when the measured concentration of the ozonated water mixture satisfies a previously set concentration range,
wherein the mixing of the treating liquid and the ozonated water is performed using an in-line mixing method.

9. The ozonated water mixture supply method of claim 8, wherein the mixing of the treating liquid and the ozonated water is performed by disposing a mixing valve and a static mixer in a line in which the treating liquid and the ozonated water flow.

10. The ozonated water mixture supply method of claim 8, wherein the process unit comprises a unit cleaning a substrate in a single wafer process.
